(19) United States
(12) Patent Application Publication
(10) Pub. No.: US 2002/0067502 A1
(43) Pub. Date: Jun. 6, 2002

(54) Methods for digitally printing composite documents

(76) Inventor: David R. Hansen, Honeoye Falls, NY (US)

Correspondence Address: Curt J. Whitenack, McDonnell Boehnen Hulbert & Berghoff, 32nd Floor, 300 S. Wacker Drive, Chicago, IL, 60606, US

(21) Appl. No.: 09/729,302

(22) Filed: Dec. 4, 2000

(51) Int. Cl. G06F 15/00; B41J 1/00

(52) U.S. Cl. 358/1.15

(57) ABSTRACT

Methods for digitally printing composite documents. A printer groups pages in the document that have a common attribute on a digital printing system. The system stores identifiers, such as metatags, in the electronic version of the document to define the page groups. The printer also associates the identifier of a page group with a printing device. Upon instruction from the printer, the system prints the pages belonging to an identified group on the associated printing device.

### COPYRIGHT

A portion of this disclosure of this patent document contains material that is subject to copyright protection. The copyright owner has no objection to the facsimile reproduction by anyone of the patent disclosure, as it appears in the Patent and Trademark Office patent files or records, but otherwise reserves all United States and International copyright rights whatsoever.

### FIELD OF INVENTION

The present invention relates to digital printing. More specifically, it relates to methods for digitally printing composite documents.

### BACKGROUND OF THE INVENTION

Digital printing is changing the printing industry. In digital printing, a customer creates an electronic version of a document and sends it to a printer operator for final formatting, printing, and assembly on selected printing devices. Digital printing is mutually advantageous to both the customer and the printer operator: the customer has greater control over what the final document will look like because the electronic version that he creates accurately communicates his vision to the printer operator; and the printer operator spends less time in formatting the document because he can immediately appreciate the customer's vision of the final printed document, and he can return a corrected electronic version to the customer for the customer's proofing and approval. Thus the printer operator and the customer may refine a document together before the final print run by means of a shared electronic version.

The customer typically sends a job to the printer operator in pieces or he creates a cohesive document in an electronic form using print document creation software such as that provided by Adobe Systems Inc. of Palo Alto, Calif. under the name, “Acrobat.” The print document creation software allows customers to combine elements of the document from text files, image files, and outputs of other computer programs into the cohesive document. For example, a document may simultaneously contain text to be printed in a selected font from a word processor output file, a bitmapped image stored as a graphics file, and the output from a spreadsheet program. The print document creation software typically presents the customer with a what-you-see-is-what-you-get (“WYSIWYG”) image on a computer monitor that represents the final print document. The print document creation software incorporates the contents of files into the document, provides layout functions for scaling and combining the various elements on the page, displays the layout on the computer monitor, and outputs a composite electronic document for storage and transfer. Also, editing and rearrangement of the elements may be immediately viewed on the computer monitor. In such a manner, customers have substantial autonomy over the contents and layout of the document while creating the electronic version, unencumbered by considerations of the printing devices and the media on which they print.

The printer operator is responsible for creating a final, cohesive, print document for production. If the customer sends his print job to the printer operator as separate pieces or separate files, the printer operator typically assembles a cohesive document for proofing as a WYSIWYG file. Alternatively, the customer submits the print job to the printer operator already in the form of a WYSIWYG file.

Although WYSIWYG software may be a boon to the customer, it may be a bane to the printer operator. The customer may take full advantage of the features of the WYSIWYG software and combine elements of disparate format in a composite document. For example, a customer may combine text, low resolution black and white graphics, and high resolution color graphics, all in the same composite document. Moreover, the composite document may even combine different formats on the same page. Also the document may require different pages to be printed on different media, such as tabbed pages, section dividers, or various colored or textured paper. Thus the printer operator has to scrutinize the contents of the electronic version of the document and decide how to print the various formats and media.

No single printing device can efficiently accommodate every format or media. For example, printing text, black and white graphics, or low resolution images on a high resolution color printing device is an inefficient use of the capabilities of the color printing device and can be prohibitively expensive. Therefore, according to present practice, the printer operator typically divides the composite document into separate files, each of which is allocated to a printing device appropriate to the formatting and media in the file. The printer operator adapts the contents of each file to conform to the properties of its associated printing device, and prints the files on the respective printing devices. For example, a particular printing device may optimally print eight text pages as a quarto, four pages on each side of a sheet of paper, for later cutting and binding into four double-sided leaves. Using this device to print text is a much more efficient use of the printer operator's resources than printing each page on a color printing device.

After printing, the printer operator returns the separate print jobs to the customer for assembly into the final document, or the printer operator assembles the document himself and charge the customer for the labor involved. However, after reviewing proofs of the document from the printer operator, if the customer wants to make amendments to the document as a WYSIWYG file before committing to the final document, the printer operator has to construct a semblance of the original electronic version to record the customer's corrections and retain the adaptations to the printing devices without having to reintroduce the printing device adaptations again at a later stage of proofing.

It is therefore desirable to maintain the integrity of the electronic version of a composite document in such a way that the printer operator may make adaptations for different formatting, media, and printing devices in the same electronic version as the customer introduces creative changes and proofing. By maintaining the integrity of the electronic version, the printer operator need not physically divide the electronic version for separate printing, reconstitute the document for proofing, and reenter the adaptations for the printing devices. Also, the customer receives the electronic version for proofing in the same WYSIWYG format as he sent it to the printer operator, and thus need not concern himself with what adaptations the printer operator has made for printing the composite document on the various printing devices.

It is also desirable that the printer operator have the ability to designate on which printing devices the various pages or elements of the composite document should be printed without compromising the integrity of the electronic version.

It is further desirable that the printer operator has the ability to group the pages or elements destined for a specific printing device and print them together without printing pages or elements associated with other printing devices. The pages destined for the same printing device may be non-consecutive, and the present method of searching the document for pages of the same group and printing each one of them separately is highly inefficient. Such a grouping feature allows the printer operator to examine the output for each format or media separately, and permits efficient processing of print jobs when some printing devices may be in use for other print jobs or are offline.

It is also desirable that the printer operator has the option of diverting the pages or elements intended for one printing device to an alternative printing device. Such a feature may be useful for providing the customer with proofs of a lower quality than the desired quality of the final print-run in order to save the cost to the customer and the resources of the printer operator.

### SUMMARY OF THE INVENTION

One aspect of the invention is a method for printing a group of pages of a composite document on a printing device. The method includes searching an electronic version of the document for an identifier for the group of pages. Each page of the document is associated with a corresponding section of the electronic version of the document. A computer gathers each section of the electronic version that is associated with the identifier into an output data stream, and the computer directs the output data stream to the printing device for printing.

Another aspect of the invention is a method for grouping pages of a composite document for printing on a printing device. The method includes assigning an identifier to a group of pages. A computer associates the identifier with sections of an electronic version of the document that correspond to the group of pages. Each page of the document is associated with a corresponding section of the electronic version of the document.

Yet another aspect of the invention is a digital printing system. The system includes at least one printing device and a computer connected to the at least one printing device. The computer runs a program that gathers each section of an electronic version of a document associated with an identifier into an output data stream. Each page of the document is associated with a corresponding section of the electronic version of the document. The program also associates the identifier with a printing device selected from the at least one printing device, and directs the output data stream to the selected printing device for printing.

A further aspect of the invention is a method for using a digital printing system. The method includes selecting a group of pages of a document and assigning an identifier to the group of pages. The group of pages is defined according to a common attribute. The printer operator also associates a printing device with the assigned identifier and inputs the assigned identifier to the digital printing system in response to a print prompt. In this manner, the associated printing device prints the group of pages having the assigned identifier.

### BRIEF DESCRIPTION OF THE DRAWINGS

The foregoing and other features and advantages of preferred embodiments of the present invention will be more readily apparent from the following detailed description, which proceeds with references to the accompanying drawings, in which:

FIG. 1 is a block diagram illustrating a configuration of a digital printing system;

FIG. 2 is a flow diagram illustrating a method for grouping pages of a composite document for printing on a printing device in the digital printing system of FIG. 1;

FIG. 3 is source code for defining a page options object in Portable Document Format;

FIG. 4 is a flow diagram illustrating a method for printing a group of pages of a composite document on a printing device in the digital printing system of FIG. 1; and

FIG. 5 is a flow diagram illustrating a method of using the digital printing system of FIG. 1.

### DETAILED DESCRIPTION OF PREFERRED EMBODIMENTS

Digital printing requires that a printer operator create an electronic version of a composite document before the final print run. Typically, the electronic version of the document is a computer readable file written in a Page Description Language (“PDL”). PDL files contain commands in American Standard Code for Information Interchange (“ASCII”) format. An advantage of storing a document as a PDL file is that the PDL file is typically much smaller than if the document were stored as a bitmapped image file. The printing device reads the PDL file and performs printing functions according to the instructions in the PDL file. Sending instructions to the printing device in ASCII code is more efficient than creating a bitmapped image of the document and then sending the bitmapped image to the printing device. For example, it is much more efficient to send a few ASCII characters to the printing device that instruct the printing device to print the string “PDF” in 24 point Times New Roman font than it is to create a bitmapped image of the string at 600 dots per inch resolution and then send the whole bitmapped image to the printing device. Examples of PDL file formats are the Portable Document Format (“PDF”) format and the PostScript format, both by Adobe Systems Inc. of Palo Alto, Calif.

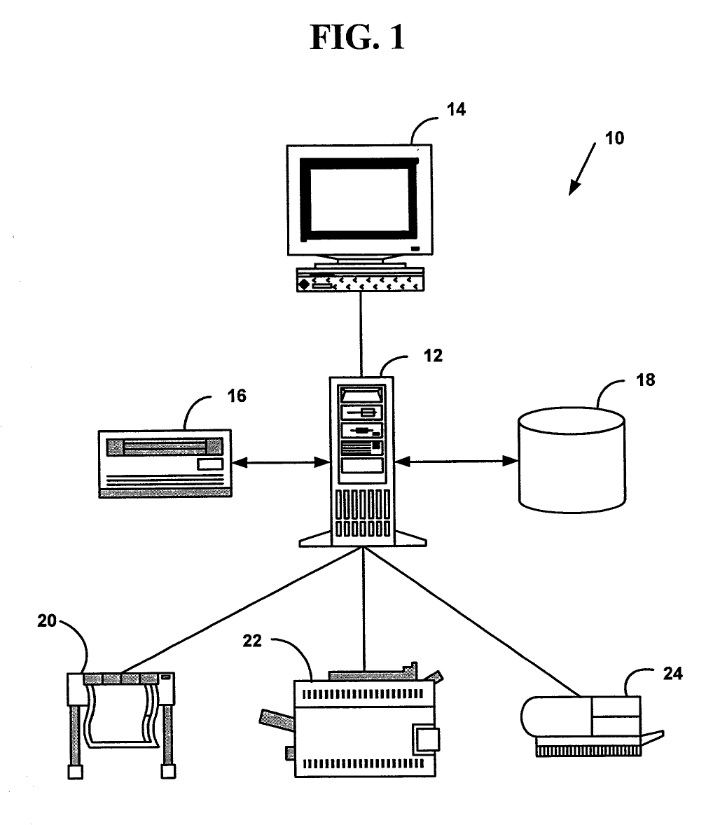

PDL files are typically stored on a computer readable medium and are accessible by a computer running a Print Document Management System program. FIG. 1 is a block diagram illustrating a digital printing system 10. A printer operator formats a document by altering an electronic version of the document on a computer 12 running the Print Document Management System program. The printer operator views changes to the document on a computer monitor 14 providing a WYSIWYG representation of the document. The electronic version of the document may be read from or recorded to a portable computer readable medium by means of a portable medium drive 16 such as a CD-ROM drive, a floppy disk drive, or a Zip drive familiar to those of ordinary skill in the computing art. For example, the customer may provide a PDF file to the printer operator on a CD-ROM, which the printer operator loads into a CD-ROM drive and reads the PDF file into memory on the computer 12. After formatting the document using the Print Document Management System software, the printer operator may write the amended PDF file to another CD-ROM in the CD-ROM drive and send the CD-ROM to the customer for proofing. Also, the printer operator may archive the electronic version on a computer readable storage medium 18 such as a hard disk drive or a tape drive.

When ready for printing, the printer operator instructs the computer 12 to send some or all of the PDL file to one or more printing devices 20-24. Each printing device 20-24 processes the PDL instructions that it receives from the computer 12 and prints one or more pages of the document. It is to be understood, however, that the present invention is not limited to the devices or configuration shown in FIG. 1 and that other devices and configurations could be used. Also, the electronic versions of the documents need not be in PDL format and need not be stored on CD-ROMS, floppy disks, or hard disks. Many other formats for storing the document in electronic form are possible, such as in graphical format, and on other storage media, and the present invention is not restricted to the formats and media described herein.

An operating environment for the computer 12, printing devices 20-24, and other devices of the present invention includes a processing system with at least one Central Processing Unit (“CPU”) (not shown) and a memory system (not shown). Preferably, a CPU (not shown) controls the operations of the computer 12. In accordance with the practices of persons skilled in the art of computer programming, the preferred methods are described herein with reference to acts and symbolic representations of operations that are performed by the processing system, unless indicated otherwise. Among its acts and operations, the CPU instructs the printing devices 20-24 to load fonts, perform diagnostics, and process PDL files for printing. The CPU may also instruct the computer's 12 memory system to read or write data, such as PDL files, to or from the portable media device 16 or the computer readable storage medium 18. One CPU on which the preferred methods may run and which may be incorporated into the preferred embodiments of the apparatus is a “x86” series processor manufactured by Intel Corporation, of Santa Clara, Calif., although it should be understood that the present invention is not restricted to this series of processors and that other processors may be used.

It will be appreciated that the acts and symbolically represented operations include the manipulation of electrical signals by the CPU. The electrical signals represent data bits that cause a resulting transformation or reduction of the electrical signal representation. The computer 12, printing devices 20-24, and other devices maintain data bits at memory locations in their respective memory system to reconfigure or otherwise alter their CPU's operation, as well as other processing of signals. The memory locations, such as random access memory (“RAM”), are physical locations that have particular electrical, magnetic, or optical properties corresponding to the data bits, depending on the type of memory used.

Defining Page Groups

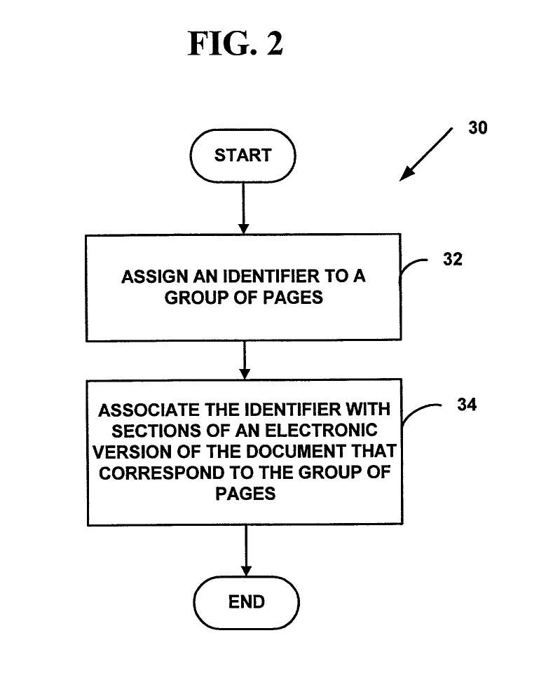

FIG. 2 is a flow diagram illustrating a method 30 for grouping pages of a composite document for printing on a printing device. The method 30 includes assigning an identifier to a group of pages at step 32. At step 34, the method 30 associates the identifier with sections of an electronic version of the document that correspond to the group of pages. Each page of the document is associated with a corresponding section of the electronic version of the document. In this manner, the printer operator can instruct the computer 12 to alter the electronic version of the composite document so that the computer 12 may later identify which pages belong in the group having a particular identifier.

For example, the printer operator may determine that one group of pages requires printing on a high-resolution color printer because the pages in the group have a common attribute in that they contain detailed color graphics, whereas the other pages of the document only require printing on a medium-resolution black-and-white printer because they contain simple text. The printer operator would therefore group the color pages together by assigning an identifier to the group. The identifier may take the form of a text string, e.g. “hi-res color” or it may take the form of a parameter that is internally recognized by the Print Document Management Software. The printer operator associates this identifier with the pages in the electronic version of the document. Typically, the printer operator stores the identifier within the electronic version of the document, which may be stored on the portable media drive 16, RAM in the computer 12, or on the computer readable storage medium 18.

In a preferred embodiment, the electronic version of the document is in a PDL format such as a PDF file or a PostScript file. The associating step 34 stores the identifier within the PDL file. A PostScript file comprises sections, each of which corresponds to a page of the document. The PostScript file contains the sections in sequence, starting with section corresponding to the first page of the document and ending with the section corresponding to the last page. Each section may accept instructions for identifying the page that are not displayed on the computer monitor 14 or printed on a printing device 20-24. Such instructions are termed “metatags” by those of ordinary skill in the digital printing art. Thus the method 30 may store the identifier as a metatag in each section in the PostScript file that corresponds to a page in the group.

A preferred PDL format, however, is the PDF format. Typically, the computer 12 processes the PostScript file sequentially in order to find a particular page. Thus the computer 12 must process all previous pages of the PostScript file before reaching a sought page of the group. The PDF format provides more efficient processing because it allows the computer 12 jump to the specific location in the PDF file where a sought page begins. The PDF file contains a separate section that contains a “page options” object, as is known to those of ordinary skill in the digital printing art. This object retains the location of where each section, corresponding to a distinct page, is in the file. The computer 12 may therefore examine the “page options” object section of the file, determine the location of a particular section in the PDF file, and go straightway to that location without having to process the intervening sections.

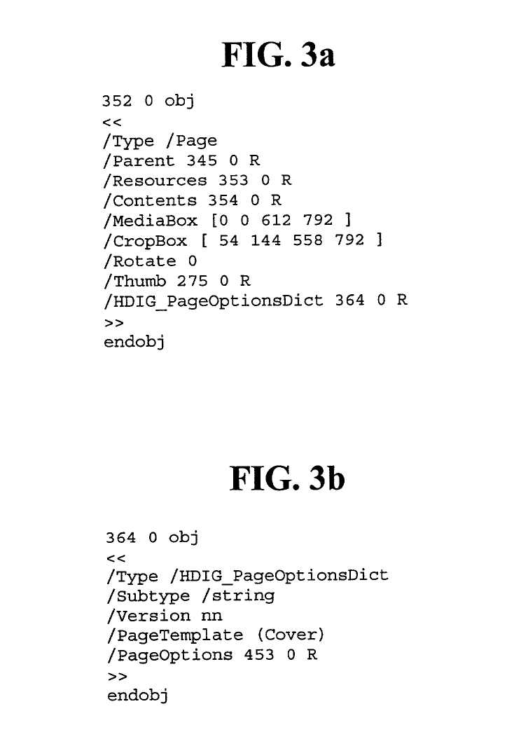

In a preferred embodiment, the computer 12 stores the group identifier in an object section of the PDF document, such as the section corresponding to the “page options” object. FIG. 3 is source code for defining a “page options” object in Portable Document Format. FIG. 3a defines a “page root” object familiar to those of ordinary skill in creating PDF documents. Included in this “page root” object is a “page options dictionary” object of the form of Expression 1:

/HDIG_PageOptionsDict 364 0 R (1)

The computer 12 stores the “page options dictionary” object as object number 364 from the definition in Expression 1. FIG. 3b defines the “page options dictionary” object of Expression 1. Included in the “page options dictionary” object is a “page options” object of the form of Expression 2:

/PageOptions 453 0 R (2)

The computer 12 stores the “page options” object as object number 453 from the definition in Expression 2. The computer 12 stores the group identifier and the pages in the group together in the “page options” object. The group identifier may be a metatag for the pages of the group. In this manner, the computer 12 may efficiently find the locations of sections in the electronic version corresponding to the pages of the group by examining the “page options” object and correlating the locations with the identifier. It should be understood, however, that the preferred embodiments are not limited to the definitions of FIG. 3 or the forms of the objects in Expressions 1 and 2, and that other forms and definitions of the objects are possible.

In an alternative preferred embodiment, the computer 12 stores the group identifier in the sections of the electronic version that correspond to the group of pages. For example, the computer 12 may store the identifier in a metatag at the beginning of each section. An example of a metatag for a PDF file may be of the form of Expression 3:

<group>hi-res_color<\group> (3)

indicating that when the printer requests printing of the group “hi-res color,” all sections of the electronic version of the composite document that contain this metatag are output to a selected printing device.

Any particular page of the composite document may belong to more than one group of pages. Page groups within a composite document need not be mutually exclusive. For example, a page that contains both color graphics and plain text may belong to page groups appropriate to each of these page attributes. If the printer operator chooses only to print all pages with plain text for spell checking, or chooses only to print all pages with color graphics for analyzing color quality, the page belonging to both groups will print. Additionally, pages that do not belong to any identified page groups may themselves define a “null” page group. This may allow the printer operator to print the pages of the null page group on a default printing device 20-24.

Printing Page Groups

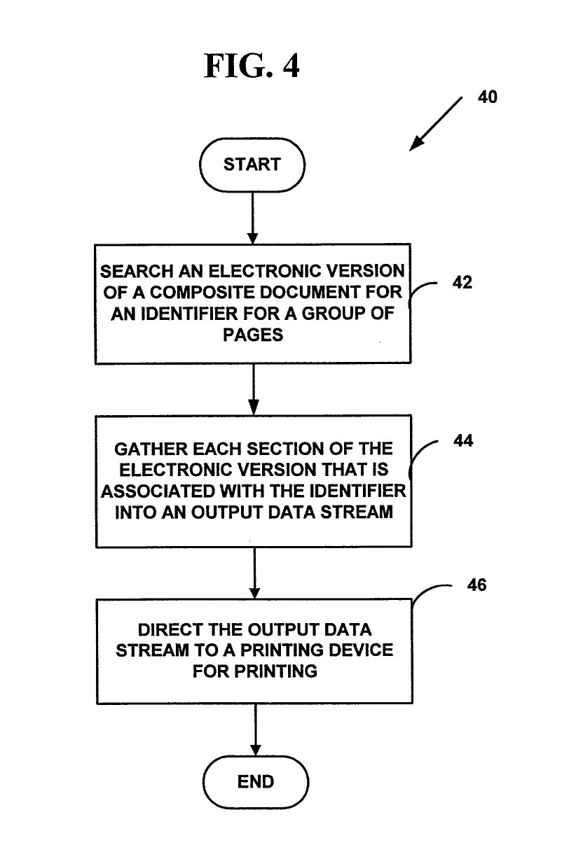

FIG. 4 is a flow diagram illustrating a method 40 for printing a group of pages of a composite document on a printing device 20-24. The method 40 includes searching an electronic version of the document for an identifier for the group of pages at step 42. Each page of the document is associated with a corresponding section of the electronic version of the document. At step 44, each section of the electronic version that is associated with the identifier is gathered into an output data stream. The output data stream is directed to the printing device for printing at step 46. In this manner, the printer operator may direct the computer 12 to print only the group of pages with the particular identifier on the printing device 20-24.

For example, the printer operator may decide to print only the pages in the group “hi-res color.” The computer 12 searches the electronic version of the composite document in order to extract the sections corresponding to the pages in this group. In one preferred embodiment, the identifier is stored in each section that corresponds to a page in the group. For example, the computer 12 may sequentially search through the electronic version of a PostScript file seeking a metatag of the form of Expression 3. Having found the metatag, the computer 12 gathers the section within which the metatag appears. The computer 12 continues sequentially searching the electronic version of the document, similarly gathering each section that contains the metatag. Having gathered the sections, or while gathering the sections, the computer 12 outputs them to the printing device 20-24 as an output data stream by methods familiar to those of ordinary skill in the computing art.

In an alternative preferred embodiment, the identifier is stored in a separate section of the electronic version of the composite document. For example, the “pages option” object of a PDF file, such as that defined in FIG. 3 and illustrated in Expression 2, may contain the identifier. The computer 12 searches the object and extracts the location of the sections within the PDF file that correspond to the pages in the group. The computer 12 goes to the locations and gathers each section that was referenced in the object into an output data stream. Having gathered, or while gathering the sections, the computer 12 outputs them to the printing device 20-24 as an output data stream by methods familiar to those of ordinary skill in the computing art.

The printer operator may choose on which printing device 20-24 to print the group of pages when assigning the identifier to the group of pages at step 32 of method 30. For example, when assigning the identifier “hi-res color” to the group of pages, the printer operator may select that the group is to be printed on a specific printing device 20-24 for high resolution color graphics. Such a selection may be made by entering an address or other label that tells the computer 12 to format the sections for compatibility with the input requirements of the printing device 20-24 and to direct the resulting data stream to an output port to which the printing device 20-24 is attached. Using methods familiar to those of ordinary skill in computing, when viewing the document on the computer monitor 14, the printer operator may pull down a menu in the Graphical User Interface (“GUI”) that allows the printer to create a new page group. The computer 12 may prompt the printer operator, in a dialog box, to enter an identifier for the page group. At the same time as entering the identifier, the computer 12 may prompt the printer operator to select to which printing device 20-24 the pages associated with this identifier are to be sent. In this manner, the printer operator associates the identifier with the printing device 20-24 when creating the group of pages.

Alternatively, however, the computer 12 may request that the printer operator choose on which printing device 20-24 to print the group of pages at another time. For example, the computer 12 may prompt the printer operator to provide an identifier for a group of pages and select which pages belong to the group. But the computer 12 does not request that the printer operator associate a printing device 20-24 with the identifier at this stage in processing the composite document. At a later stage in the digital printing process, the printer operator may decide to print the group of pages. The computer 12 may prompt the printer operator to provide the identifier for the group and request that the printer operator select a printing device 20-24. For example, the printer operator may decide to print the group “hi-res color” on a high resolution color printing device 20-24 to obtain final quality copies of the page group. Alternatively, the printer operator may decide to print the same group on a low resolution black-and-white printing device 20-24 to obtain proofing quality copies at a lower cost.

In operation, the printer operator may select multiple groups of pages simultaneously for printing by inputting the identifiers for the respective page groups to the computer 12. The computer 12 may receive the inputted identifiers through the GUI by prompting the printer operator to type the identifiers into a dialog box or select the identifiers from a list of identifiers. The computer 12 prompts the printer operator to associate each identifier with a printing device 20-24. Upon associating each identifier with a printing device 20-24, the computer 12 gathers the sections of the electronic version of the document that are associated with each identifier into an output data stream for the identifier. The computer 12 associates each output data stream with the appropriate printing device 20-24 because both have been associated with the identifier, and the computer 12 directs each output data stream to its respective printing device 20-24, where it is processed and printed. Thus the digital printing system may simultaneously print batches of page groups.

Moreover, the printer operator may select one page group for printing on a printing device 20-24, while instructing the printing device 20-24 to replace the pages belonging to other page groups with media insertion commands. Such a feature is helpful when the composite document contains media printed on other printing devices 20-24 and the print job requires a common finishing. For example, for a document that contains both a color graphics page group and a plain text page group, the printer operator may first print the page group for the color graphics pages on a color printing device 20-24 and in the quantity desired. After printing the color page group, the printer operator places these copies into an insert supply of a text printing device 20-24. The printer operator may then instruct the computer 12 to print the pages in the text page group on the text printing device 20-24 and replace the pages in the color page group with an insert command. In this manner, the computer 12 instructs the text printing device 20-24 to insert the color pages at the correct places within the document during the printing of the text pages. The printer operator may then finish the combined set of color and text pages as a complete document.

Using the Digital Printing System

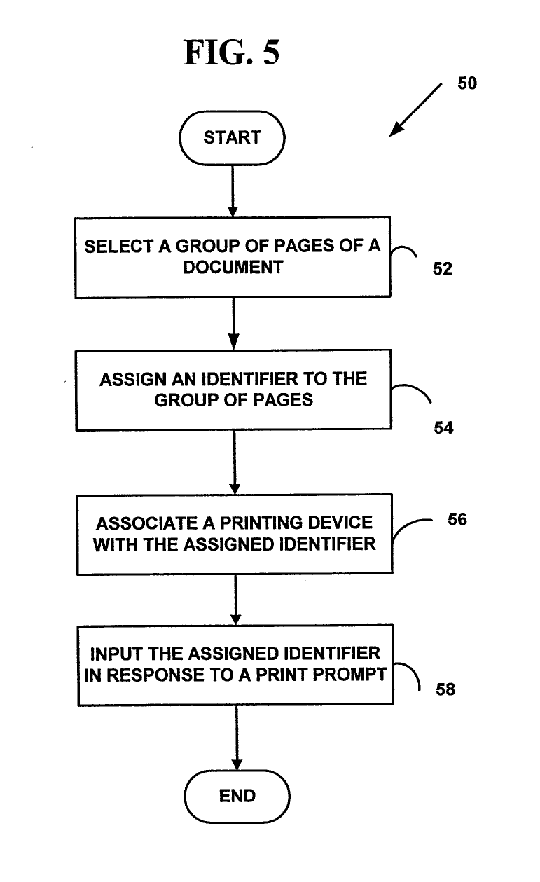

FIG. 5 is a flow diagram illustrating a method 50 of using a digital printing system 10. In operation, the printer operator selects a group of pages of a document at step 52. The group of pages is defined according to a common attribute. At step 54, the printer operator assigns an identifier to the group of pages. The printer operator associates a printing device 20-24 with the assigned identifier at step 56. At step 58, the printer operator inputs the assigned identifier to the digital printing system 10 in response to a print prompt. As a consequence, the associated printing device 20-24 prints the group of pages having the assigned identifier.

For example, the printer operator may, by means of a pull down menu of the GUI presented on the computer monitor 14, initiate selection of a group of pages. The computer 12 prompts the printer operator, by means of a dialogue box of the GUI, to select which pages belong to the group. Upon selecting the group of pages, the computer 12 may prompt the printer operator to assign an identifier to the group of pages by typing the identifier into the dialogue box. Contemporaneously, and within the same dialogue box, the printer operator may associate the identifier with a printing device 20-24 Alternatively, the printer operator may initiate an association at a later time by means of a pull-down menu, and the computer 12 responds by presenting a dialogue box on the computer monitor 14 by which the printer operator associates the printing device with the identifier.

When the printer operator is ready to do the print run, the digital printing system 10 prompts the printer operator to input the identifier for the group that is to be printed. The prompt from the digital printing system 10 may be in response to the printer operator indicating a decision to perform the print run by pulling down a menu or clicking on a “print” icon in the GUI. The prompt could take the form of a dialogue box opening on the computer monitor 14. Alternatively, the prompt may be an audible signal from the printing device 20-24. Upon inputting the identifier for the chosen group, the digital printing system 10 prints the pages of the group on the assigned printing device 20-24. It should be understood, however, that the method 50 is not limited to the operations through the GUI of the computer 12 as described above and that other operations for selecting, assigning, associating, and inputting are possible.

It should be understood that the programs, processes, methods, systems and apparatus described herein are not related or limited to any particular type of computer apparatus (hardware or software), unless indicated otherwise. Various types of general purpose or specialized computer apparatus may be used with or perform operations in accordance with the teachings described herein.

In view of the wide variety of embodiments to which the principles of the invention can be applied, it should be understood that the illustrated embodiments are exemplary only, and should not be taken as limiting the scope of the present invention. For example, the steps of the flow diagrams may be taken in sequences other than those described, and more or fewer elements or component may be used in the block diagrams.

The claims should not be read as limited to the described order or elements unless stated to that effect. In addition, use of the term “means” in any claim is intended to invoke 35 U.S.C. §112, paragraph 6, and any claim without the word “means” is not so intended. Therefore, all embodiments that come within the scope and spirit of the following claims and equivalents thereto are claimed as the invention.

I claim:

1. A method for printing a group of pages of a composite document on a printing device, the method comprising the steps of:
searching an electronic version of the document for an identifier for the group of pages, wherein each page of the document is associated with a corresponding section of the electronic version of the document;
gathering each section of the electronic version that is associated with the identifier into an output data stream; and
directing the output data stream to the printing device for printing.

2. A computer readable medium, having stored therein instructions for causing a central processing unit to execute the method of claim 1.

3. The method of claim 1 further comprising the step of:
requesting a selection of the printing device on which to print the group of pages.

4. The method of claim 1 wherein the identifier is stored in a separate section of the electronic version of the document, and wherein the separate section comprises location information for each section of the electronic version of the document that is associated with the group of pages.

5. The method of claim 1 wherein the identifier is stored in each section of the electronic version of the document that is associated with the group of pages.

6. The method of claim 1 wherein the electronic version of the document is in a Page Description Language.

7. The method of claim 6 wherein the Page Description Language is a Portable Document Format.

8. The method of claim 6 wherein the identifier is a metatag.

9. The method of claim 1 further comprising the steps of:
searching the electronic version of the document for another identifier for another group of pages;
directing an insert command to the printing device for each section that is associated with the other identifier.

10. A method for grouping pages of a composite document for printing on a printing device, the method comprising the steps of:
assigning an identifier to a group of pages; and
associating the identifier with sections of an electronic version of the document that correspond to the group of pages, wherein each page of the document is associated with a corresponding section of the electronic version of the document.

11. A computer readable medium, having stored therein instructions for causing a central processing unit to execute the method of claim 10.

12. The method of claim 10 wherein the associating step comprises:
storing the identifier in a separate section of the electronic version of the document, wherein the separate section comprises location information for the sections of the electronic version of the document that correspond to the group of pages.

13. The method of claim 10 wherein the associating step comprises:
storing the identifier in the sections of the electronic version of the document that correspond to the group of pages.

14. The method of claim 10 wherein the electronic version of the document is in a Page Description Language.

15. The method of claim 14 wherein the Page Description Language is a Portable Document Format.

16. The method of claim 14 wherein the identifier is a metatag.

17. A digital printing system comprising:
at least one printing device; and
a computer connected to the at least one printing device, wherein the computer executes a program that performs the steps of:
gathering each section of an electronic version of a document associated with an identifier into an output data stream, wherein each page of the document is associated with a corresponding section of the electronic version of the document;
associating the identifier with a printing device selected from the at least one printing device; and
directing the output data stream to the selected printing device for printing.

18. The system of claim 17 wherein the program is a plug-in to a Print Document Management System.

19. A method for using a digital printing system, the method comprising the steps of:
selecting a group of pages of a document, wherein the group of pages is defined according to a common attribute;
assigning an identifier to the group of pages;
associating a printing device with the assigned identifier; and
inputting the assigned identifier to the digital printing system in response to a print prompt, whereby the associated printing device prints the group of pages having the assigned identifier.

20. A method for printing a group of pages of a composite document on a printing device, the method comprising the steps of:
searching for an identifier for the group of pages in a separate section of an electronic version of the document, wherein electronic version of the document is in a Portable Document Format and each page of the document is associated with a corresponding section of the electronic version of the document, and wherein the separate section comprises location information for each section of the electronic version of the document that is associated with the group of pages;
gathering each section of the electronic version that is associated with the identifier into an output data stream; and
directing the output data stream to the printing device for printing.

21. A computer readable medium, having stored therein instructions for causing a central processing unit to execute the method of claim 20.

22. A method for grouping pages of a composite document for printing on a printing device, the method comprising the steps of:
assigning an identifier to a group of pages; and
storing the identifier in a separate section of an electronic version of the document, wherein the electronic version of the document is in a Portable Document Format and each page of the document is associated with a corresponding section of the electronic version of the document, and wherein the separate section comprises location information for the sections of the electronic version of the document that correspond to the group of pages.

23. A computer readable medium, having stored therein instructions for causing a central processing unit to execute the method of claim 22.
